(19) United States
(12) Patent Application Publication
(10) Pub. No.: US 2008/0155277 A1
(43) Pub. Date: Jun. 26, 2008

(54) Hardware partitioned trust

(76) Inventors: Mallik Bulusu, Olympia, WA (US); Vincent J. Zimmer, Federal Way, WA (US); Michael A. Rothman, Puyallup, WA (US)

Correspondence Address: INTEL CORPORATION;c/o INTELLEVATE, LLC, P.O. BOX 52050, MINNEAPOLIS, MN, 55402, US

(21) Appl. No.: 11/644,686

(22) Filed: Dec. 26, 2006

(51) Int. Cl. G06F 12/14

(52) U.S. Cl. 713/193

(57) ABSTRACT

An apparatus, method, and system are disclosed. In one embodiment, the apparatus comprises a trusted platform module to store a plurality of contexts, wherein each context includes stored security information for one of a plurality of physical partitions in a computer system.

### FIELD OF THE INVENTION

The invention relates to trusted platform modules.

### BACKGROUND OF THE INVENTION

Hardware partitioning is quickly becoming a necessary feature in enterprise platforms. The ability to seamlessly build ever-larger servers in a seamless fashion by permutation of the links will drive this scale-up revolution.

In addition, legislation such as Sarbanes-Oxley (SOX), the Health Information Protected Authorization Act (HIPAA) will require more trust across all elements of the enterprise. With over 200 companies now members of the Trusted Computing Group, collaboration on the design of trust infrastructure and hardware roots of trust, such as the Trusted Platform Module (TPM), trust-based computing is also becoming a vital part of many computer systems.

### BRIEF DESCRIPTION OF THE DRAWINGS

The present invention is illustrated by way of example and is not limited by the figures of the accompanying drawings, in which like references indicate similar elements, and in which:

FIG. 1 describes one embodiment of a multi-context trusted platform module (TPM).

FIG. 2 describes an embodiment of two single-context TPMs that synchronize security information directly with each other.

FIG. 3 describes one embodiment of a computer system with a multi-context TPM.

FIG. 4 describes one embodiment of a computer system with two single-context TPMs that synchronize security information directly with each other.

FIG. 5 is a flow diagram of one embodiment of a process to manage security information in a computer system with a multi-context TPM.

### DETAILED DESCRIPTION OF THE INVENTION

Embodiments of an apparatus, method, and system for a hardware partitioned trust are described. In the following description, numerous specific details are set forth. However, it is understood that embodiments may be practiced without these specific details. In other instances, well-known elements, specifications, and protocols have not been discussed in detail in order to avoid obscuring the present invention.

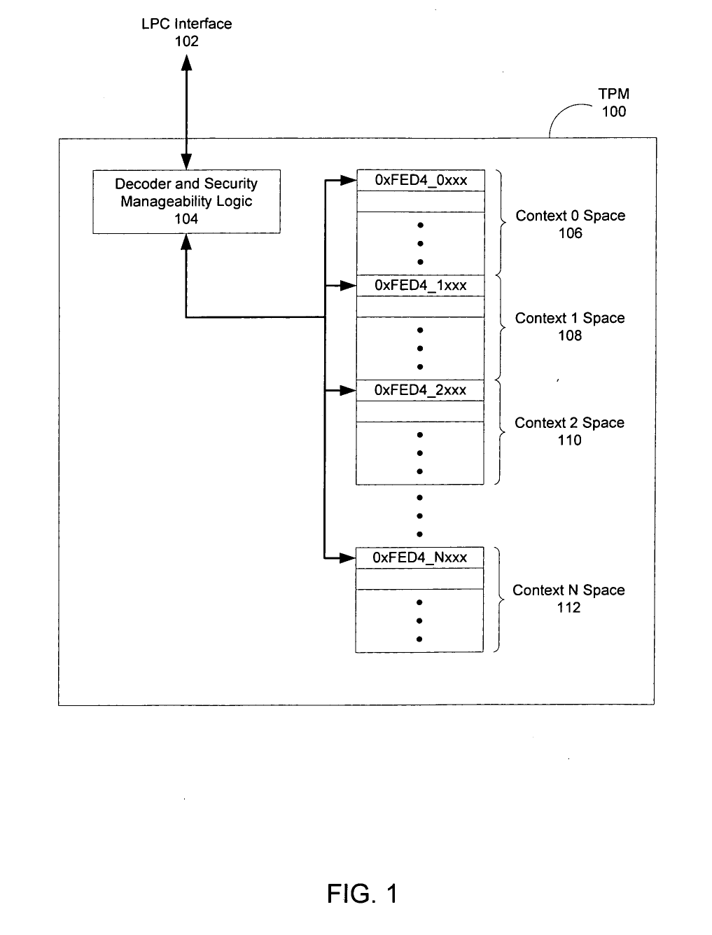

FIG. 1 describes one embodiment of a multi-context trusted platform module (TPM). In different embodiments, the TPM 100 may be a discrete device in a computer system or a device built into a chipset or other system management device. In one embodiment a discrete TPM 100 is coupled to the low pin count (LPC) interconnect. The LPC interconnect transports information between the TPM 100 and the LPC interface 102 located in the south bridge (commonly referred to as the I/O Controller Hub or ICH) of a computer system. The TPM 100 device manages and stores information related to the security of the computer system in which it is located. For example, the TPM may store security keys such as an Endorsement Key or a Storage Root Key that allow secure access to the computer system to minimize the risks of losing or compromising important data from hacking, viruses, worms, etc.

In one embodiment, the TPM 100 stores information from more than one context within the computer system. A context relates to the information regarding a particular hardware partition in the computer system. For example, there may be two processors on the system and memory for each processor. In this system configuration, a first context can be utilized for the first processor and memory and a second context for the second processor and memory. Thus, in this example, each of the two partitions can operate essentially as separate computer systems although they are physically in the same system.

In the two partition example, each of the two processors can communicate with the other processor or any other device located within the system by sending a transaction across one or more point-to-point interconnects coupling each of the processors in the system to all other processors in the system. Additionally, in one embodiment, each processor is coupled to the north bridge of a chipset located in the computer system through a point-to-point interconnect as well. A transaction directed to the TPM is routed through one of the one or more chipsets within the system, which direct the transaction to the TPM. In the embodiment shown in FIG. 1, the TPM 100 is a discrete device coupled to the LPC interconnect. In another embodiment, the TPM may be an embedded device within the chipset itself.

Thus, in FIG. 1, one or more transactions arrive from the LPC interface 102 to decoder and security manageability logic 104. Each point-to-point interconnect transaction has an embedded partition identifier that allows the device receiving the transaction to know which partition the transaction originated from. In one embodiment, the decoder and security manageability logic 104 decodes the point-to-point interconnect transaction to read the partition identifier and determine the context that is active. In one embodiment, the TPM has storage space for storing security information associated with each context (context 0 space 106 through context N space 112). In the two partition example described above, context 0 space 106 and context 1 space 108 are utilized to store the security information associated with the two partitions. Furthermore, the security manageability logic in 104 incorporates the standard logic associated with a TPM and thus can interact with devices on the system through the LPC interconnect to provide necessary processes to secure the system using the security information stored in one or more of the context spaces (106-112).

In the embodiment illustrated in FIG. 1, the system address for the TPM 100 starts at a memory mapped I/O address of 0xFED40000. Additionally, in this embodiment, each stored context has an associated address space of 0xFED4N000 to 0xFED4NFFF, wherein N equals the number of contexts in the system. This address space (and associated memory storage locations with security information) is commonly referred to as the TPM Interface Space (TIS). In other embodiments, the address range per TIS may increase or decrease from the amount in the illustrated example. In another embodiment, special TPM memory access commands are utilized by the south bridge of the computer system to access the TPM instead of standard memory mapped I/O. Thus, the TPM 100 will access the security information of the context associated with the partition identifier decoded from the transaction.

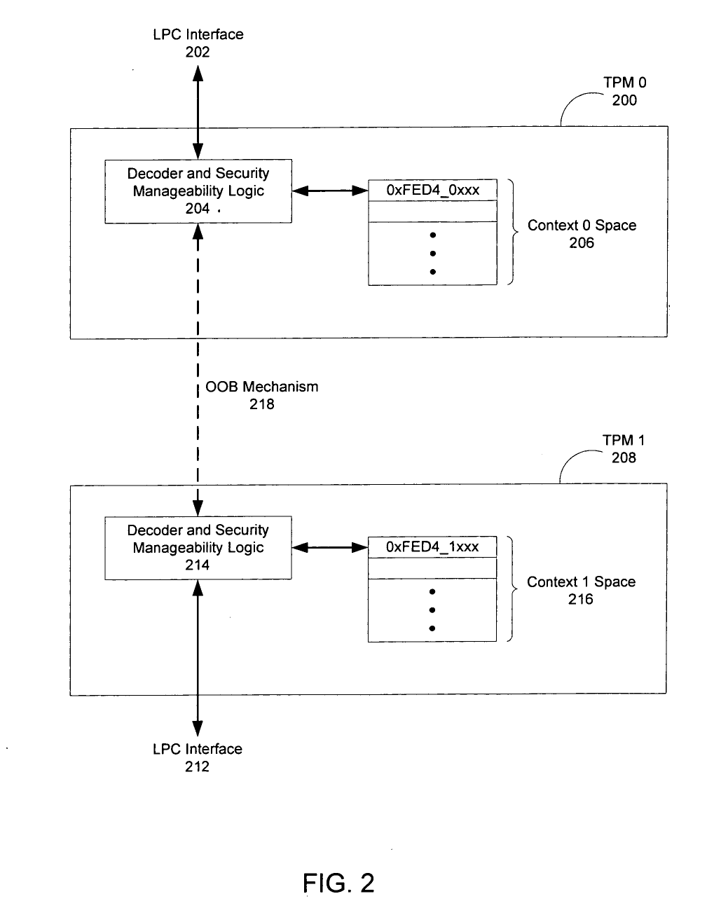

FIG. 2 describes an embodiment of two single-context TPMs that synchronize security information directly with each other. In different embodiments, each TPM may be a discrete device in a computer system or a device built into a chipset or other system management device.

In this embodiment, a first TPM, TPM 0 (200), manages and stores security information for a first context of the computer system. Thus, TPM 0 (200) is specific to a first hardware partition that includes a processor, a memory, and a chipset. In one embodiment, TPM 0 (200) is coupled to the LPC interconnect for the first partition. The LPC interconnect sends information between TPM 0 (200) and the LPC interface 202 located in the south bridge portion of the chipset in the first partition. The general functionality of TPM 0 (200) regarding managing and storing security information is similar to the TPM associated with FIG. 1. The primary differentiation is that TPM 0 (200 in FIG. 2) stores only one context of the computer system, specifically the context associated with the first partition. The first partition's context-specific information is stored in context 0 space 206.

Any point-to-point interconnect transaction that TPM 0 (200) receives from the system through the LPC interconnect is decoded by the decode and security manageability logic 204 in TPM 0 (200) to determine whether the transaction relates to context 0. If so, the security manageability logic within 204 utilizes standard logic associated with a TPM and thus can interact with devices on the system through the LPC interconnect to provide necessary processes to secure the system using the security information stored in within context 0 space 206.

Additionally, in one embodiment, a second TPM, TPM 1 (208), manages and stores security information for a second context (relating to a second partition of the computer system). Thus, TPM 1 (208) is specific to a second hardware partition that includes a different processor, a memory, and chipset than the processor, memory, and chipset of the first partition. In one embodiment, TPM 1 (208) is coupled to the LPC interconnect for the second partition. The LPC interconnect sends information between TPM 1 (208) and the LPC interface 212 located in the south bridge portion of the chipset in the second partition. The general functionality of TPM 1 (208) is the same as TPM 0 (200) except that it stores a different context, context 1 space 216.

Any point-to-point interconnect transaction that TPM 1 (208) receives from the system through the LPC interconnect is decoded by the decode and security manageability logic 214 in TPM 1 (200) to determine whether the transaction relates to context 1. If so, the security manageability logic within 214 utilizes standard logic associated with a TPM and interacts with devices on the system through the LPC interconnect to provide necessary processes to secure the system using the security information stored in within context 1 space 216.

In one embodiment, TPM 0 (200) and TPM 1 (208) communicate with each other to synchronize any globally-related security information common to both partitions/contexts. In another embodiment, TPM 0 (200) and TPM 1 (208) communicate with each other to synchronize all security information. The synchronization occurs across an out-of-band mechanism 218. An out-of-band mechanism is an interconnect that can potentially operate without the computer system it is located in completely booting to an operating system. In one embodiment, the out-of-band mechanism is Intel® Active Management Technology (AMT). In another embodiment, the TPMs are embedded devices with two separate south bridges and a first Manageability Engine (usually in the north bridge of the chipset) linked to TPM 0 (200) is utilized to communicate from the first partition to TPM 1 (208) in the second partition or to a second Manageability Engine in the second partition, which in turn communicates with TPM 1 (208). In one embodiment, the Manageability Engine in the north bridge communicates with devices in, and coupled to, the south bridge with a Controller Link, which is a simple 2-line out-of-band interconnect between the north and south bridge. In another embodiment, a dedicated interconnect connects all TPMs within a computer system to each other. In other embodiments, any potential out-of-band mechanism available as a means for communication may be utilized to provide a way of transferring information between multiple TPMs on the same computer system.

In different embodiments, the out-of-band communication between TPMs can occur when the system shut down, when the system is in a low power mode, during the boot process, during the system shutdown process, or any other period of time where the operating system is not fully operational. In another embodiment, the TPMs can communicate across the mechanism when the system is fully operational in response to a system interrupt or other notification of a change in security policy, procedure, key, or other security information change.

The transactions arrive from the LPC interface 202 and/or 212 to each decoder and security manageability logic (204 and 214 respectively). As discussed above in relationship to FIG. 1, each point-to-point interconnect transaction has an embedded partition identifier that allows the device receiving the transaction to know which partition the transaction originated from. The decoder and security manageability logic for each partition will read the partition identifier and determine the context that is active. In the embodiment illustrated in FIG. 2, the system address for TPM 0 (200) starts at a memory mapped I/O address of 0xFED40000. Additionally, in this embodiment, the stored context 0 space 206 (the context 0 TIS) has an associated address space of 0xFED40000 to 0xFED40FFF. The system address for TPM 1 (208) starts at a memory mapped I/O address of 0xFED41000. The stored context 1 space 216 (the context 1 TIS) has an associated address space of 0xFED41000 to 0xFED41FFF. In other embodiments, the address range for the context 0 TIS and context 1 TIS may increase or decrease from the amount in the illustrated example. In another embodiment, special TPM memory access commands are utilized by the south bridge of the computer system to access the TPM instead of standard memory mapped I/O.

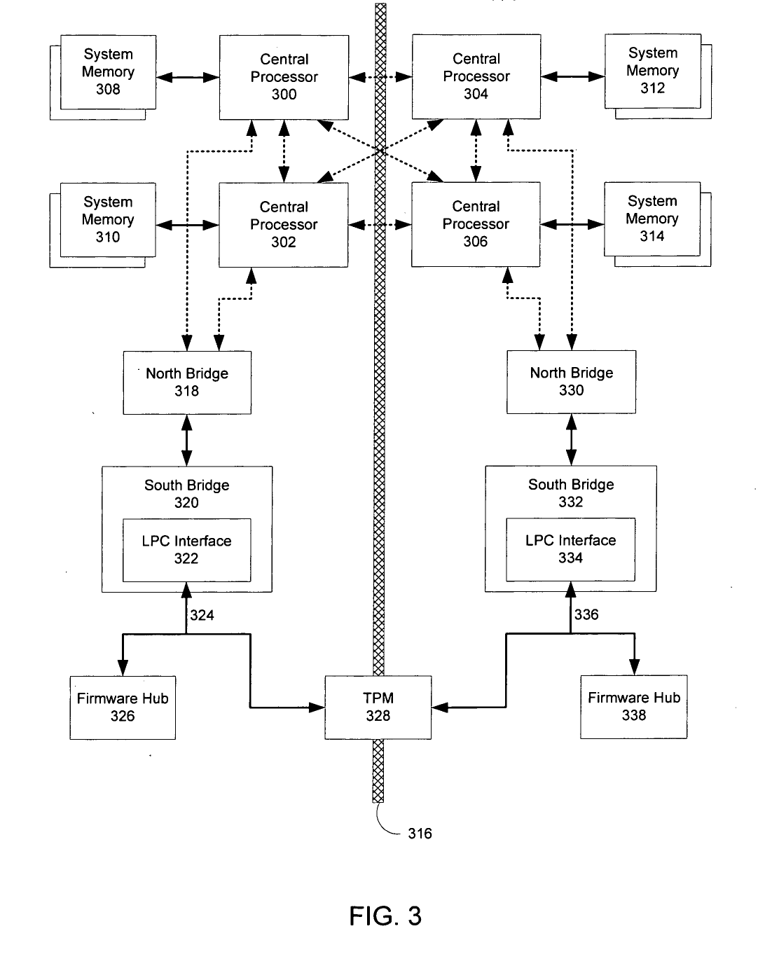

FIG. 3 describes one embodiment of a computer system with a multi-context TPM. In this embodiment, the computer system has four central processors 300-306. In different embodiments, central processors 300-306 may or may not be multi-core processors. System memories 308-314 are coupled to each of the central processors 300-306 respectively. In one embodiment, the computer system in FIG. 3 has two partitions (shown separated by the thick partition line 316). A first partition includes central processors 300 and 302 as well as system memories 308 and 310. A second partition includes central processors 304 and 306 as well as system memories 312 and 314. All four central processors 300-306 may communicate with each other across point-to-point interconnects. All point-to-point interconnects in the system in FIG. 3 are shown as the dotted arrow lines.

Additionally, each partition has an associated chipset that includes at least a north bridge and a south bridge. Central processors 300 and 302 communicate directly to the chipset in the first partition through individual point-to-point interconnects to north bridge 318. Central processors 304 and 306 communicate directly to the chipset in the second partition through individual point-to-point interconnects to north bridge 330. North bridge 318 is coupled through a hub-link to south bridge 320 and north bridge 330 is coupled through a hub-link to south bridge 332. Both south bridges have an LPC interface (322 and 334 respectively) embedded. The LPC interconnects (324 for the first partition and 336 for the second partition) link the south bridge 320 of the chipset to one or more devices located on the LPC interconnects (324 and 336). In one embodiment, firmware hubs 326 and 338 are coupled to their respective LPC interconnects.

In one embodiment, a multi-context TPM 328 is coupled to both LPC interconnects (324 and 336). The multi-context TPM 328 manages and stores information related to the security of the computer system that includes both the first and second partitions. TPM 328 stores two independent contexts, one for each partition. Each processor in the system in FIG. 3 can communicate with each of the other three processors in the system or any other device located within the system by sending a point-to-point interconnect transaction across one or more of the point-to-point interconnects. A transaction may be directed to the multi-context TPM 328 by being routed through the chipset (from the north bridge to the south bridge to the LPC interconnect). Thus, one or more transactions arrive at the multi-context TPM 328, which, in turn, decodes the transaction(s) to obtain the partition identifier(s) (as specified in FIG. 1) to determine which context is active. The TPM utilizes the stored security information related to the active context accordingly.

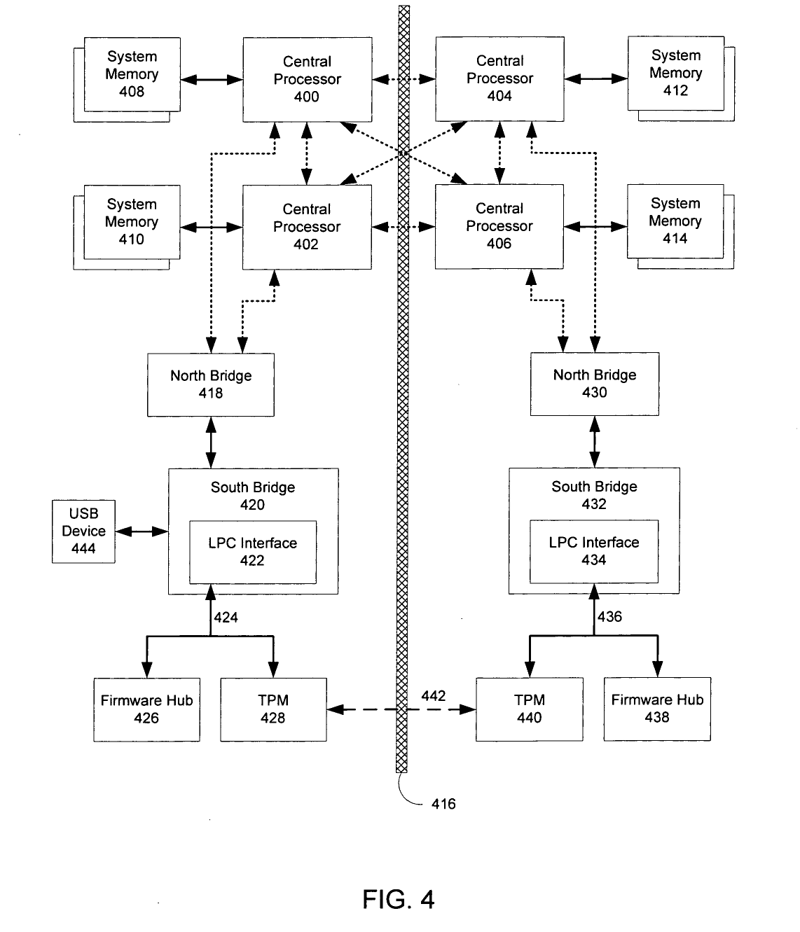

FIG. 4 describes one embodiment of a computer system with two single-context TPMs that synchronize security information directly with each other. In this embodiment, similarly to FIG. 3, the computer system has four central processors 400-406. In different embodiments, central processors 400-406 may or may not be multi-core processors. System memories 408-414 are coupled to each of the central processors 400-406 respectively. In one embodiment, the computer system in FIG. 4 has two partitions (shown separated by the thick partition line 416). A first partition includes central processors 400 and 402 as well as system memories 408 and 410. A second partition includes central processors 404 and 406 as well as system memories 412 and 414. All four central processors 400-406 may communicate with each other across point-to-point interconnects. All point-to-point interconnects in the system in FIG. 4 are shown as the dotted arrow lines.

Additionally, each partition has an associated chipset that includes at least a north bridge and a south bridge. Central processors 400 and 402 communicate directly to the chipset in the first partition through individual point-to-point interconnects to north bridge 418. Central processors 404 and 406 communicate directly to the chipset in the second partition through individual point-to-point interconnects to north bridge 430. North bridge 418 is coupled through a hub-link to south bridge 420 and north bridge 430 is coupled through a hub-link to south bridge 432. Both south bridges have an LPC interface (422 and 434 respectively) embedded. Each south bridge may also be linked one or more other devices through one or more additional interconnects coupled to the south bridge. For example, USB device 444 may be coupled to south bridge 420 through an embedded USB hub within south bridge 420. The LPC interconnects (424 for the first partition and 436 for the second partition) link the south bridge 420 of the chipset to one or more devices located on the LPC interconnects (424 and 436). In one embodiment, firmware hubs 426 and 438 are coupled to their respective LPC interconnects.

In one embodiment, single-context TPM 428 is coupled to LPC interconnect 424. TPM 428 manages and stores security information for a first context of the computer system. The first context is associated with the first partition. The LPC interconnect 424 transports information between TPM 428 and the LPC interface 422 located in south bridge 420. The general functionality of TPM 428 regarding managing and storing security information is the same as the TPMs associated with FIG. 2.

TPM 428 decodes any point-to-point transaction it receives from the system through the LPC interconnect 424 and determines whether the transaction relates to the first context by checking the decoded partition identifier in the transaction. If so, the security manageability logic within TPM 428 utilizes standard logic associated with a TPM and thus can interact with devices on the system through the LPC interconnect to provide necessary processes to secure the system using the security information stored in within the first context storage space in TPM 428.

In one embodiment, the second partition includes single-context TPM 440, which is coupled to LPC 436. All of the functionality regarding TPM 440 is the same as that which is described above for single-context TPM 428 except that TPM 440 decodes point-to-point interconnect transactions and performs security procedures associated with the second partition instead of the first partition.

In one embodiment, TPM 428 and TPM 440 communicate with each other to synchronize any globally-related security information common to both partitions/contexts. The synchronization occurs across an out-of-band mechanism 442. In different embodiments, the out-of-band mechanism may be Intel® Active Management Technology (AMT), a Manageability Engine and associated interconnects, a separate dedicated cross-TPM interconnect, or any other potential out-of-band mechanism that is available as a means for communication.

In one embodiment, TPM 428 and TPM 440 are embedded devices within their respective south bridges 420 and 432 (this embodiment is not illustrated, but could be easily shown by incorporating TPM blocks 428 and 440 into south bridge blocks 420 and 432 and additionally linking them again with out-of-band mechanism 442.

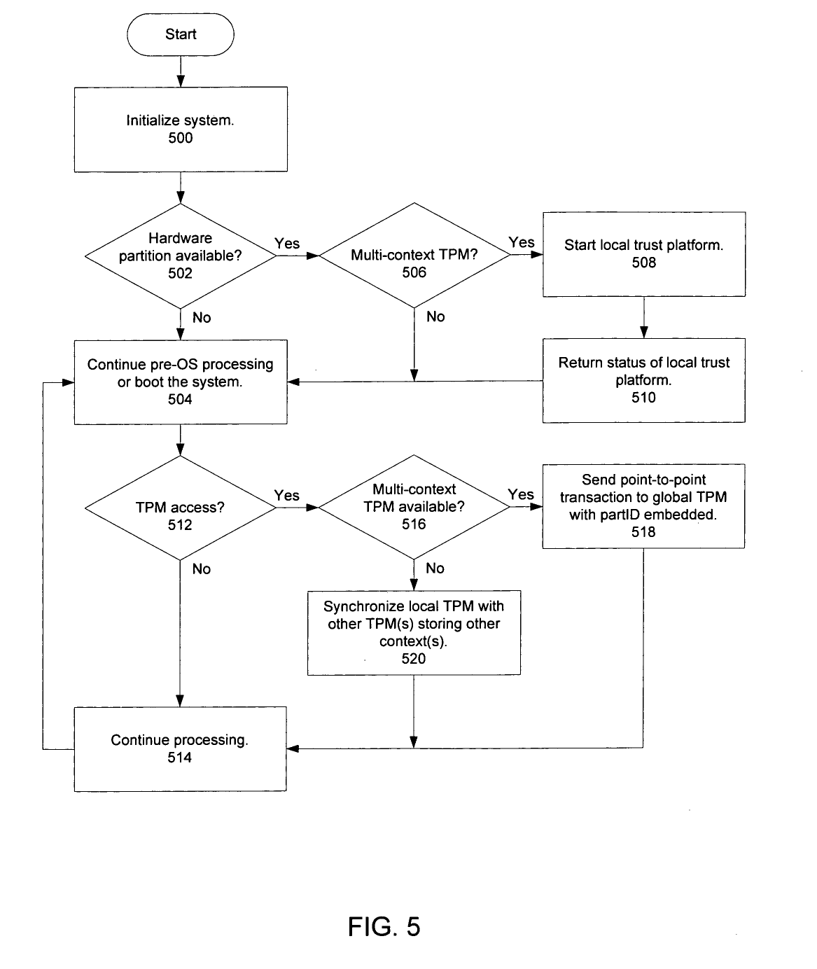

FIG. 5 is a flow diagram of one embodiment of a process to manage security information in a computer system with a multi-context TPM. The process is performed by processing logic that may comprise hardware (circuitry, dedicated logic, etc.), software (such as is run on a general purpose computer system or a dedicated machine), or a combination of both. Referring to FIG. 5, the process begins by processing logic initializing the system (processing block 500). This may include initially powering the system and reading the basic input/output system (BIOS). Next, processing logic checks to see if a hardware partition is available on the system (processing block 502). If there is no partition, processing logic continues to boot the system or process pre-OS boot blocks (processing block 504).

If there is a partition, processing logic next checks to see if there is a multi-context TPM (processing block 506). If there is not a multi-context TPM present in the local partition, processing logic continues to boot the system or process pre-OS boot blocks (processing block 504). Otherwise, if there is a multi-context TPM locally present, then processing logic starts the local trust platform within the multi-context TPM (processing block 508) and then returns the status of the local trust platform within the multi-context TPM (processing block 510). The local trust platform is the context information that is stored per hardware partition, thus, when the computer system is initialized, the security keys and any other context specific security information becomes active upon the start of the local trust platform. If the system has a multi-context TPM available, the local trust platform per partition is stored in each of the contexts within the multi-context TPM. Returning to the process, processing logic will continue the remainder of the pre-OS processing or it will boot the system if the pre-OS processing is complete (processing block 504).

Once the system has booted, processing logic checks to see if there is access to a TPM again (processing block 512). If there is not, then processing logic continues processing normally (processing block 514). If there is access to a TPM, processing logic determines if a multi-context TPM is available (processing block 516). If a multi-context TPM is available, processing logic sends a point-to-point interconnect transaction to the multi-context global TPM with a partition identifier embedded within the transaction (processing block 518) and the processing logic continues processing (processing block 514). If there is no multi-context TPM available (i.e. a single-context local TPM is the only thing available), then processing logic synchronizes the local TPM with one or more other TPM(s) located in the system storing one or more other contexts (processing block 520) and finally processing logic will continue processing (processing block 514) and the process is complete.

Thus, embodiments of an apparatus, method, and system for a hardware partitioned trust are described. These embodiments have been described with reference to specific exemplary embodiments thereof. It will be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

What is claimed is:

1. An apparatus, comprising:
a trusted platform module to store a plurality of contexts, wherein each context includes stored security information for one of a plurality of physical partitions in a computer system.

2. The apparatus of claim 1, wherein the trusted platform module is further operable to:
receive one or more point-to-point interconnect transactions from a point-to-point interconnect in the computer system;
decode at least one of the one or more received point-to-point interconnect transactions to obtain a partition identifier in the transaction; and
determine which stored context is active in the computer system from the partition identifier.

3. The apparatus of claim 2, wherein the security information is stored in a TPM interface space (TIS).

4. The apparatus of claim 3, wherein the TIS comprises memory mapped input/output (I/O).

5. The apparatus of claim 4, wherein the TPM determines which TIS is active by reading the partition identifier.

6. The apparatus of claim 1, wherein the stored security information includes at least one security key.

7. An apparatus, comprising:
a trusted platform module (TPM) to store a single context, wherein the context includes stored security information for one of a plurality of physical partitions in a computer system, and the TPM to synchronize at least a portion of the stored security information with one or more other TPMs in the computer system.

8. The apparatus of claim 7, wherein to synchronize comprises exchanging information between the TPM and the one or more other TPMs on an out-of-band mechanism.

9. The apparatus of claim 8, wherein the out-of-band mechanism comprises Active Management Technology.

10. The apparatus of claim 7, wherein each of the one or more other TPMs store a single context, wherein each context stored on each of the one or more other TPMs includes stored security information for one or more separate physical partitions in the computer system.

11. The apparatus of claim 7, wherein the stored security information includes at least one security key.

12. A method, comprising:
storing a plurality of contexts on a single trusted platform module (TPM), wherein each context includes stored security information for one of a plurality of physical partitions in a computer system.

13. The method of claim 12, further comprising:
receiving one or more point-to-point interconnect transactions from a point-to-point interconnect in the computer system;
decoding at least one of the one or more received point-to-point interconnect transactions to obtain a partition identifier in the transaction; and
determining which stored context is active in the computer system from the partition identifier.

14. The method of claim 12, wherein the stored security information includes at least one security key.

15. A system, comprising:
a first interconnect;
a first processor coupled to the first interconnect;
a first chipset coupled to the first interconnect;
a second interconnect;
a second processor coupled to the second interconnect;
a second chipset coupled to the second interconnect;
a trusted platform module (TPM) coupled to the first and second chipsets, the trusted platform module to store a plurality of contexts, wherein each context includes stored security information for one of a plurality of physical partitions in the system; and
a universal serial bus (USB) hub coupled to the first and second chipsets.

16. The system of claim 15, wherein the trusted platform module is further operable to:
receive one or more point-to-point interconnect transactions from a point-to-point interconnect in the computer system;
decode at least one of the one or more received point-to-point interconnect transactions to obtain a partition identifier in the transaction; and
determine which stored context is active in the computer system from the partition identifier.

17. The system of claim 16, wherein the security information is stored in a TPM interface space (TIS) comprising memory mapped input/output (I/O).

18. The system of claim 17, wherein the TPM determines which TIS is active by reading the partition identifier.

19. The system of claim 15, wherein the TPM is coupled to the input/output controller hub (ICH) portion of the chipset.

20. A system, comprising:
a first interconnect;
a first processor coupled to the first interconnect;
a first chipset coupled to the first interconnect;
a second interconnect;
a second processor coupled to the second interconnect;
a second chipset coupled to the second interconnect;
a first trusted platform module (TPM) coupled to the first chipset, the first TPM to store a first context of a first partition that includes the first interconnect, first processor, first chipset, and stored security information relevant to at least the first context, wherein the first TPM is operable to synchronize at least a portion of the stored security information relevant to at least the first context with a second TPM in the system;
the second TPM coupled to the second chipset, the second TPM to store a second context of a second partition that includes the second interconnect, second processor, second chipset, and stored security information relevant to at least the second context, wherein the second TPM is operable to synchronize at least a portion of the stored security information relevant to at least the second context with the first TPM; and
a universal serial bus (USB) hub coupled to the first and second chipsets.

21. The system of claim 20, wherein to synchronize comprises exchanging security information between at least the first TPM and the second TPM over an out-of-band mechanism.

22. The apparatus of claim 21, wherein the out-of-band mechanism comprises an asynchronous transfer mode interconnect.
